(19) United States
(12) Patent Application Publication
(10) Pub. No.: US 2025/0247905 A1
(43) Pub. Date: Jul. 31, 2025

(54) CONFIGURABLE ELECTRONIC DEVICE, CONFIGURATION METHOD THEREOF, AND SYSTEM HAVING THE ELECTRONIC DEVICE

(71) Applicant: LEDVANCE GmbH, Garching bei München (DE)

(72) Inventors: Wuqiang LIAO, Shenzhen Guangdong (CN); Heng LI, Shenzhen Guangdong (CN)

(21) Appl. No.: 19/039,974

(22) Filed: Jan. 29, 2025

(30) Foreign Application Priority Data
Jan. 31, 2024 (CN) 202410137185.4

(51) Int. Cl. H04W 76/14; H04W 76/11

(52) U.S. Cl. CPC H04W 76/14; H04W 76/11

(57) ABSTRACT

A configurable electronic device, configuration method thereof, and system having the electronic device are disclosed. A method for configuring a configurable electronic device is provided. According to the method, the electronic device includes a first communication module and a second communication module, and may be configured by a programmer. The method includes establishing a wireless connection between the programmer and the first communication module, and sending a first set of parameters from the programmer to the first communication module for parameterizing the second communication module. The method further includes sending a second set of parameters from the second communication module to the programmer via the first communication module, and establishing a wireless direct connection between the programmer and the second communication module when the programmer receives the second set of parameters. Additionally, a configurable electronic device and a system are provided.

### CROSS-REFERENCE TO RELATED APPLICATIONS

This patent application claims the benefit of and priority to Chinese Patent Application No. 202410137185.4, filed on Jan. 31, 2024, which is herein incorporated by reference in its entirety.

### FIELD OF THE DISCLOSURE

The present application generally relates to electronic devices. Specifically, the present disclosure relates to a method for configuring an electronic device, a configurable electronic device, and a system having such electronic device.

### BACKGROUND

Configurable electronic devices such as drivers for driving electronic consumer products (e.g., light-emitting diode or LED luminaires) are known. Furthermore, electronic drivers with dual in-line package (DIP) switches, potentiometers, or other types of user interfaces (UIs) for manual configuration of the driver are also known. Programmable drivers with universal serial bus (USB), universal asynchronous receiver-transmitter (UART), or inter-integrated circuit (I2C) interfaces are also known, which may be adjusted electronically using dedicated programming tools and software. However, such drivers require circuit connections and specially customized programmers, making it difficult to perform post-manufacturing modifications, particularly after the driver has been installed.

Some known electronic devices (e.g., LED drivers) support wireless protocols such as Bluetooth, Zigbee, and Wi-Fi. Bluetooth® is a registered trademark of the Bluetooth Special Interest Group. ZigBee® is a registered trademark of the ZigBee Alliance. Additionally, Digital Addressable Lighting Interface (DALI)-compatible drivers are known, allowing parameter adjustment using DALI controllers. DALI® is a registered trademark of the international standardization alliance for lighting and building automation networks. However, most wireless networks require frequent operations, such as network entry for configuration. Moreover, it is difficult to separate professional operations from daily operations, leading to network misunderstandings and incorrect operations. Devices with near-field communication (NFC) interfaces are also known. However, configuration of such devices still requires close proximity to the programmer, which becomes particularly inconvenient after the configurable device (e.g., luminaire and/or driver) has been installed. Furthermore, each time parameters are read or written, the NFC area of the device needs to be re-tapped.

### SUMMARY

The objective of the present application is to provide a particularly reliable and user-friendly method for configuring electronic devices.

According to a first aspect, a method is provided for configuring a configurable electronic device through a programmer, wherein the electronic device includes a first communication module and a second communication module. Specifically, the first and second communication modules of the electronic device may be wireless communication modules that are functionally connected to each other and configured to communicate with the programmer via two separate wireless communication paths.

The method includes establishing a wireless connection between the programmer and the first communication module or a first communication channel, specifically via the first communication channel, and sending a first set of parameters from the programmer to the second communication module.

The method further includes sending a second set of parameters from the second communication module to the programmer via the first communication module.

The method further includes establishing a wireless direct connection between the programmer and the second communication module when the programmer receives the second set of parameters. Specifically, the programmer may be configured to automatically connect to the second communication module after receiving the second set of parameters.

The first set of parameters may include setting parameters for the second communication module, such as Bluetooth settings parameters, encryption keys, operation commands, and/or backup data.

The second set of parameters may include parameters of the second communication module and/or encryption keys for connecting the programmer to the second communication module.

Once the connection between the programmer and the second communication module is established, any further communication between the programmer and the electronic device can occur via the direct connection.

Specifically, during the initial configuration phase, communication between the programmer and the electronic device may be executed via the first communication module, while any subsequent configuration of the electronic device may be executed via the direct connection between the programmer and the second communication module.

Due to this two-phase configuration, settings made by professional users in the first phase or factory settings may be isolated from settings made by daily users later or field settings. By isolating professional user settings from daily user operations, any incorrect operation or misunderstanding caused by conflicts between different settings may be avoided.

In some embodiments, the second set of parameters is at least partially encrypted in the first communication module before being sent to the programmer. Due to the encryption step of the second set of parameters, the risk of any unauthorized access to the second set of parameters or parameters of the second communication module may be reduced.

The method may include sending a set of device parameters, such as driver parameters, from the programmer to the second communication module via the direct connection to parameterize the electronic device, such as an LED driver. The device parameters may include any parameters needed for configuring the electronic device. Specifically, once the direct connection with the second communication module is established, the device parameters may be pre-stored in a memory unit of the programmer and retrieved.

The method may include retrieving a set of backup data for parameterizing the electronic device, particularly through the second communication module. In some embodiments, the backup data may be retrieved from a memory unit of the first communication module and mixed with the device parameters provided by the programmer. Thus, the configuration of the electronic device may be based on both the device parameters and backup data or historical data.

The method may also include visualizing current device parameters on the user interface of the programmer, particularly based on mixed parameters of device operating parameters and backup data. If needed, visualization of current device parameters can help the user perform any modification or adjustment of device parameters.

The method may also include modifying visualized parameters via the user interface of the programmer. Specifically, the user interface may be configured as an interactive user interface for visualizing and modifying the configuration of the electronic device.

The method may include sending the modified device parameters to the second communication module and updating the configuration of the electronic device based on the modified operating parameters. Specifically, the steps of visualization, modification, sending, and updating may be executed repeatedly and multiple times. Any subsequent configuration of the electronic device may also be achieved via the direct connection between the programmer and the second communication module.

The communication between the first communication module and the programmer may be based on a near-field wireless communication protocol and/or the communication between the second communication module and the programmer may be based on a short-range wireless communication protocol. Specifically, the first communication module may be configured as an NFC module, and the second communication module may be configured as a Bluetooth module. Thus, during the first phase or initial phase of configuration, communication between the programmer and the first communication module may be executed when the programmer and the electronic device are very close to each other. In the second phase of configuration, once the direct connection between the programmer and the second communication module is established, the programmer does not need to be very close to the electronic device. This may be particularly helpful when the electronic device is configured as part of a device network where multiple electronic devices are distributed over a larger area, as any further configuration may be executed via short-range communication without needing to bring the electronic device close to the programmer. Due to the aforementioned two-phase configuration, the electronic device may be configured in a particularly secure and reliable manner. Specifically, the first configuration phase that may be executed by professional users in a factory environment and the second configuration phase that may be executed by daily users in a field environment may be isolated from each other.

In some embodiments, the configurable electronic device is a configurable driver for driving a light source, particularly an LED light source. The driver for LED light sources or LED driver may be part of a lighting network that includes multiple luminaires or LED luminaires and multiple drivers or LED drivers, which may be interfered, for example, across residential, office, and/or outdoor areas. Due to the aforementioned two-phase configuration, the lighting network may be configured in a particularly secure and reliable manner. In the case of LED drivers, the configuration of the driver may include setting or adjusting one or more of the following parameters: output current, output voltage, dimming control parameters, temperature condition parameters (e.g., threshold temperature), power factor correction (PFC), fault detection and protection settings, input voltage range, and/or frequency settings.

According to a second aspect, a configurable electronic device is provided. The electronic device includes a first communication module and a second communication module, wherein the first communication module and the second communication module are operatively connected to each other and configured for communication with a programmer. The first communication module is configured to receive a first set of configuration parameters for parameterizing the second communication module from the programmer, and to send the configuration parameters to the second communication module. The second communication module is configured to receive the first set of configuration parameters and send a second set of configuration parameters to the programmer via the first communication module, to establish a connection between the programmer and the second communication module when the programmer receives the second set of configuration parameters. Once the connection between the programmer and the second communication module is established, any further communication between the programmer and the electronic device can occur via the direct connection between the programmer and the second communication module. Thus, the first phase of configuration executed via communication between the programmer and the first communication module and the second phase of communication between the programmer and the second communication module may be isolated from each other. Therefore, the risk of conflicts between the configurations executed by professional users (particularly during the first phase of configuration) and the configurations executed by daily users may be isolated from each other, thereby reducing the risk of incorrect operation of the electronic device.

The first communication module may be configured to encrypt the second set of parameters before sending them to the programmer. By encrypting the second set of parameters, the risk of any unauthorized access to the second set of parameters or parameters of the second communication module may be reduced.

The first communication module may include a memory unit configured to store backup data or backup device parameters, and the second communication module may be configured to retrieve backup data from the memory unit of the first communication module. Thus, the configuration or parameterization of the electronic device may be based on both device parameters and backup data.

The second communication module may be configured to execute an update of the configuration of the electronic device when receiving modified parameters from the programmer. Specifically, the second communication module may be configured to automatically update the configuration of the electronic device when receiving modified parameters from the programmer. Thus, any subsequent configuration or parameterization of the electronic device may be facilitated.

The first communication module may be further configured to communicate with the programmer based on a near-field wireless communication protocol, and the second communication module may be configured to communicate with the programmer based on a short-range wireless communication protocol. Thus, after the first configuration phase, any further configuration may be executed via short-range communication without needing to bring the electronic device close to the programmer.

According to a third aspect, a system is provided. The system includes a configurable electronic device according to the second aspect and a programmer for configuring the electronic device. The programmer is configured to communicate with a first communication module and a second communication module of the electronic device. The programmer further includes a user interface, wherein the user interface is configured to receive user input for configuring the electronic device. The user interface may also be configured to visualize current device parameters. Specifically, during the second phase of configuration, any modification or adjustment of device parameters may be executed by the user in a convenient manner based on the visualized current device parameters.

In the following description, details are provided to describe embodiments of the present specification. However, it will be apparent to those skilled in the art that various embodiments may be practiced without these details.

Some parts of the embodiments have similar parts. Similar parts may have the same names or similar reference numerals. Where appropriate, the description of one part applies by reference to another similar part, thereby reducing text repetition without limiting the present disclosure.

### BRIEF DESCRIPTION OF THE DRAWINGS

FIG. 1 shows a schematic block diagram of a system according to an embodiment,

FIG. 2 shows a schematic block diagram of a system according to an embodiment,

FIG. 3 shows a schematic block diagram of a power supply of a configurable electronic device according to an embodiment, and

FIG. 4 shows a flow chart of a method for configuring a configurable electronic device according to an embodiment.

### DETAILED DESCRIPTION

FIG. 1 shows a schematic block diagram of a system 1 according to an embodiment. The system 1 includes a configurable electronic device 2 and a programmer 3 or programming device for configuring the electronic device 2. In the embodiment of FIG. 1, the electronic device 2 is configured as an electronic driver for driving a luminaire 4. The luminaire 4 is configured as an adjustable light-emitting diode (LED) luminaire with adjustable light parameters symbolized by pictograms. The electronic device 2 and the luminaire 4 are connected via a dimming interface 5.

The electronic device 2 includes a first communication module 6, which is configured as a near-field communication (NFC) module for communication with the NFC interface 8 of the programmer 3. The NFC module 6 may include an NFC chip for recording parameters, initiating operations, and implementing security controls.

The electronic device 2 further includes a second communication module 7, which is configured as a Bluetooth module for communication with the Bluetooth interface 9 of the programmer 3.

While the illustrated embodiment uses Bluetooth for remote data exchange between a driver 2 and the programmer 3, other methods such as ultra-wideband (UWB) alternatively may be used. The Bluetooth module 7 may include a controller or microcontroller for parameter validation, parameter replacement, and interactive control between a Bluetooth module 7 and an NFC module 6. The controller may be integrated with the Bluetooth chipset.

In the schematic block diagram of FIG. 1, the NFC interface 8 and Bluetooth interface 9 of the programmer 3 are not shown.

The NFC module 6 and the Bluetooth module 7 are functionally connected to each other, represented by the double arrow connecting the NFC module 6 and the Bluetooth module 7. The wireless connections between the NFC module 6 and the Bluetooth module 7 of the electronic device 2 and the programmer 3 are symbolized by pictograms.

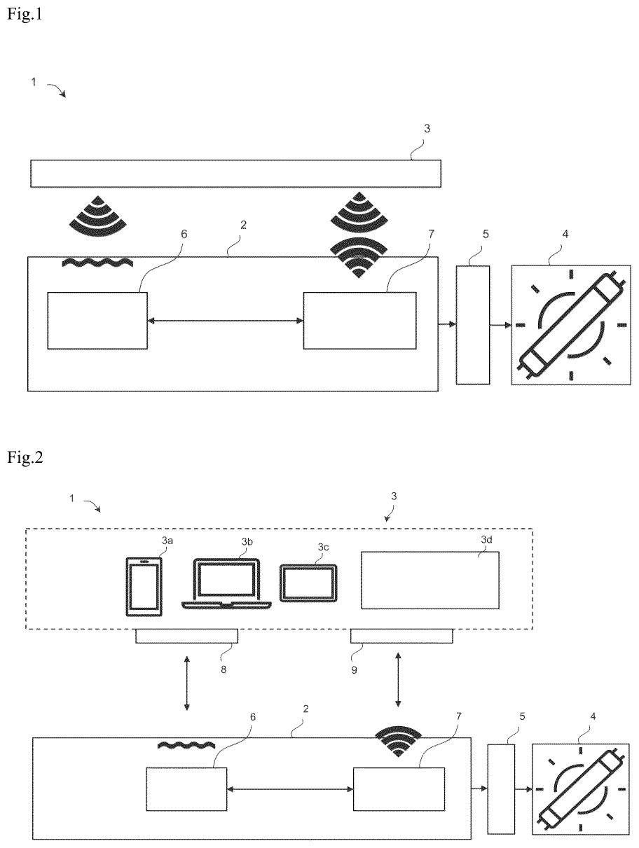

FIG. 2 shows a schematic block diagram of a system 1 according to an embodiment. In FIG. 2, different possible embodiments of the programmer 3 are shown. Specifically, a smartphone 3a, a desktop computer 3b, a tablet computer 3c, or any other customized controller 3d may be used as possible options for the programmer 3. Thus, an application, personal computer software, or customized software may be implemented on the programmer 3, specifically for data retrieval and display, input and parameter replacement, issuing parameter replacement commands, backup commands, and other command transmissions.

In FIG. 2, an NFC interface 8 and a Bluetooth interface 9 of the programmer 3 are shown. The double arrows in FIG. 2 represent the possibility of bidirectional communication between the NFC interface 8 and the NFC module 6, as well as the possibility of bidirectional communication between the Bluetooth interface 9 and the Bluetooth module 7.

Specifically, the NFC interface 8 of the programmer 3 is configured to exchange data with the NFC module 6 of the electronic device 2, and the Bluetooth interface 9 is configured to exchange data with the Bluetooth module 7 of the electronic device 2.

Data sent from the NFC interface 8 to the NFC module 6 may specifically include Bluetooth settings data or Bluetooth parameters, encryption keys, operation commands, and/or backup data.

Data received by the NFC interface 8 from the NFC module 6 may specifically include Bluetooth parameters for connecting the programmer 3 to the driver 2 through the Bluetooth interface 9.

Data sent from the Bluetooth interface 9 to the Bluetooth module 7 specifically may include driver configuration data or driver operating parameters for configuring the driver 2 and/or modifying current driver settings. Data received through the Bluetooth interface 9 from the Bluetooth module 7 may include current driver parameters, mixed driver parameters, and/or modified driver parameters.

The NFC module 6 may be configured to record and update Bluetooth channel information of current LED driver 2. The NFC module 6 may also be configured for encrypted data storage. Specifically, the NFC module 6 may be configured to store optional encryption keys for Bluetooth connection and data interaction. In some embodiments, event triggers are employed in the NFC module 6 to open the Bluetooth programming channel.

The NFC module 6 may be further configured to record various parameters related to current driver parameters to generate backup data. The backup data may subsequently be used for device replacement, for example.

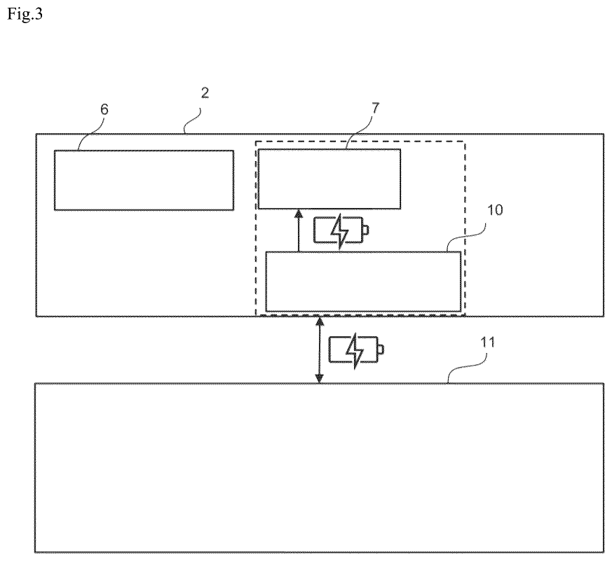

FIG. 3 shows a schematic block diagram of a power supply of a configurable electronic device 2 according to an embodiment. According to the embodiment of FIG. 3, a power supply module 10 is provided for powering the Bluetooth module 7. The power supply module 10 may include a rechargeable battery (not shown) and may be configured as an autonomous power source 11 for the Bluetooth module 7, enabling configuration of the Bluetooth module 7 even when the electronic device 2 does not have direct access to a power system. The power supply module 10 may specifically include an electrical connector or wireless connection interface for connecting the power supply module 10 to a power source 11, which may be, for example, a charger, a wireless charger, or a power pack for charging the battery of Bluetooth module 7. In some embodiments, the rechargeable battery may be configured to return at least a portion of power to the power source 11 or charge the power source 11. Thus, energy stored in the battery of electronic device 2 may be used to charge other devices in off-grid situations if needed. In FIG. 3, the power supply process is visualized through arrows and battery symbols.

According to an embodiment, the power supply may be configured to be powered from alternating current (AC) power both online and/or offline. In some embodiments, the power supply is configured as a minimal power supply solely for powering the Bluetooth module 7.

In at least some embodiments, because the final or the latest configuration information needs to be sent via Bluetooth signals, a power supply is needed when applying configuration. Therefore, a “minimal” minimum power system is needed. The minimal power supply may include, but is not limited to, wired power supplies such as USB power and/or wireless power supplies. For the minimal power supply, it is not necessary to power the entire device. It is sufficient to provide working power for the Bluetooth module 7.

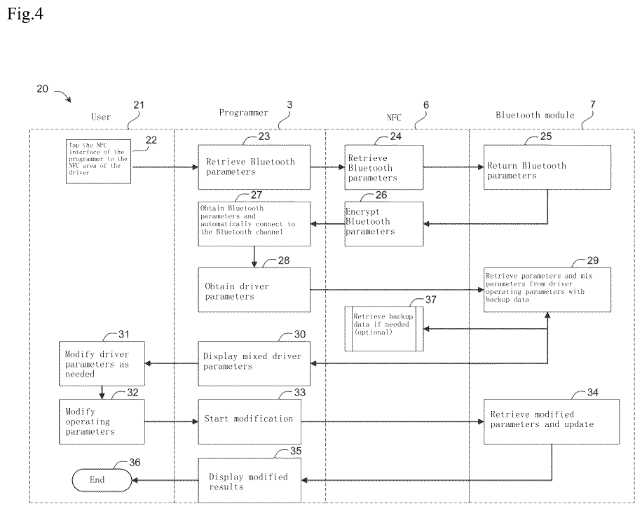

FIG. 4 shows a flow chart of a method 20 for configuring a configurable electronic device 2 according to an embodiment. The method 20 may be specifically executed by a user 21 with the aid of a system 1 according to FIG. 1 or FIG. 2.

Specifically, the method 20 may be used to configure a configurable electronic device 2, which is configured as a configurable luminaire driver or LED driver.

The configuration of the driver 2 may include setting one or more of the following driver parameters: output current, output voltage, dimming control parameters, temperature condition parameters (e.g., threshold temperature), power factor correction (PFC), fault detection and protection settings, input voltage range, and/or frequency settings.

The method 20 includes processing steps that may be executed by the user 21, the programmer 3, the NFC module 6, and the Bluetooth module 7.

In step 22, the user 21 taps the NFC interface 8 of the programmer 3 to the NFC area of the electronic device 2 or driver or the area of the NFC module 6. Specifically, the programmer 3 may be placed near the electronic device 2 such that the NFC interface 8 connects to the NFC module 6 of the driver 2. Specifically, the programmer 3 may be moved to the electronic device 2 or driver to perform an NFC area scan of the driver 2 to obtain Bluetooth parameters.

In some embodiments, Bluetooth is enabled by scanning the NFC area of driver 2, with Bluetooth defaulting to “off” for enhanced security.

In step 23, the programmer 3 retrieves a first set of parameters for transmission to the NFC module 6 of the driver 2. In step 24, Bluetooth parameters are retrieved by the NFC module 6 and transmitted to the Bluetooth module 7.

In some embodiments, in step 23, Bluetooth settings, encryption keys, operation data, and/or backup data are transmitted from the programmer 3 to the NFC module 6.

In step 25, a second set of parameters, specifically Bluetooth parameters, are returned from the Bluetooth module 7 to the NFC module 6. In step 26, the Bluetooth parameters received by the NFC module 6 are encrypted by the NFC module 6 and sent to the programmer 3.

In step 27, the programmer 3 automatically connects to the Bluetooth module 7 or the Bluetooth channel of a driver 2. Specifically, the programmer 3 connects its Bluetooth interface 9 to the Bluetooth module 7 of the driver 2 based on the encrypted Bluetooth parameters received from the NFC module 6 in step 26. Specifically, the programmer 3 may be configured to automatically establish a Bluetooth connection to the Bluetooth channel of driver 2 based on the acquired Bluetooth parameters.

In step 28, the programmer 3 retrieves a set of device parameters and sends them to the Bluetooth module 7 via the Bluetooth channel.

In step 29, the Bluetooth module 7 retrieves driver parameters. In some embodiments, recent configuration information is retrieved through the Bluetooth channel from the Bluetooth module 7. The driver 2 may be configured or parameterized at least partially based on the driver parameters retrieved by the Bluetooth module 7. Specifically, configuration of the driver 2 may be performed without further involvement of the NFC channel.

In step 30, current driver parameters are visualized by the programmer 3 on the user interface of the programmer 3, which may be either the parameters retrieved by the Bluetooth module 7 in step 29 or driver parameters mixed with backup data provided to the Bluetooth module 7.

Due to the visualization of current driver parameters, the user 21 can obtain visual information about the current settings of the driver 2.

In step 31, the user 21 can decide to modify current driver parameters or operating parameters, and in step 32, initialize the modification process of operating parameters through the user interface of the programmer 3.

In step 33, modification of driver parameters may be executed by the programmer 3, and the modified driver parameters are sent via Bluetooth channel to the Bluetooth module 7 to modify driver settings.

In step 34, the Bluetooth module 7 can receive the modified parameters and update the parameters for configuring the driver 2 accordingly.

In step 35, the modified driver parameters may be visualized on the user interface of the programmer 3, allowing the user 21 to verify driver settings before the ending process in step 36.

In some embodiments, the method 20 includes step 37, namely, retrieving backup data for the Bluetooth module 7. Specifically, backup data may be retrieved from a memory unit of the first communication module 6 or NFC module and mixed with device parameters provided by the programmer 3. Thus, the configuration of the electronic device 2 or driver may be based on both device operating parameters and backup data. Backup data or backup configuration information may be accessed from the NFC chip area as a data source or reference.

The above steps 31 to 36 may be repeated to adjust and modify the driver configuration. Such modification may be executed by the user 21 through the interactive user interface (UI) of the programmer 3. For this purpose, communication between the programmer 3 and the electronic device 2 can occur solely through the Bluetooth channel, as the direct connection between the Bluetooth module 7 and the programmer 3 was established in step 27.

Thus, according to the above method 20, wireless connection through the Bluetooth channel is established through a single tap. The method 20 also allows combination of real-time and backup data validation without requiring any additional devices.

In the first phase of configuration, data programming requires only a single tap, while secondary modifications do not require additional taps. Furthermore, data storage and data transmission are isolated to enhance security.

Through the combination of real-time data and backup data, the method 20 is characterized by a master-slave data backup function. Additionally, through coding of the Bluetooth signal, batch writing may be executed with a single tap on devices with the same batch and model range, greatly improving productivity.

The above method 20 and configurable LED driver 2 allow convenient parameter configuration in both the field and the factory. Specifically, by enabling two different communication protocols, such as an NFC protocol and a Bluetooth protocol, professional user settings may be isolated from daily user operations, helping to prevent any misunderstandings and incorrect operations caused by conflicting settings. Thus, the method 20 and electronic device 2 described here provide a particularly user-friendly solution for parameter replication and luminaire 4 replacement. In some embodiments of this method 20, in factory mode, the same Bluetooth information is stored in a batch of devices, thus facilitating the batch Bluetooth writing process.

Furthermore, the above principles apply not only to LED power supplies but also to other devices requiring field programming or parameterization.

The Bluetooth channel may be used to send current configuration parameters to the programmer 3 and forward received new configuration parameters to the microcontroller unit. Optionally, NFC encryption keys may be used to control access to the Bluetooth channel.

In some embodiments of the method 20, at the initial power-up, data integrity and write status from the NFC chip are determined. In some embodiments, data from the NFC backup source or memory unit is retrieved and applied when necessary. The Bluetooth signal and the most recent configuration data are captured and sent to both the programmer 3 and NFC module 6.

The method 20 may also include receiving the latest configuration data via the Bluetooth signal for error checking and basic data processing, then applying updated configuration parameters.

In some embodiments of the method 20, Bluetooth signals are received at predetermined intervals, and configuration data is sent to the NFC chip for backup.

Thus, the above method 20, electronic device 2, and system 1 allow easy configuration of device parameters, particularly driver parameters, with enhanced flexibility in the field or the factory. Specifically, multiple adjustments to driver parameters may be made after a single tap.

Due to the isolation of professional user settings from daily user operations, the risk of misunderstandings and incorrect operations may be minimized.

Furthermore, due to convenient parameter copying before luminaire replacement, the luminaire replacement process may be streamlined.

Automatic and secure Bluetooth access of the programmer 3 utilizes optional NFC encryption keys to enhance security, ensuring controlled access to the Bluetooth channel.

Due to data backup, a reliable channel with backup data for device replacement may be provided, contributing to the robustness and reliability of the system 1.

Furthermore, the method 20 described here is not limited to individual device operations. Specifically, in batch mode, configuration of multiple devices may be executed after a single tap. For example, after the initial tapping, multiple devices may be located with the same batch or model, and writing or configuration operations may be executed for both individual devices and entire batches of devices.

While at least one exemplary embodiment has been given in the above detailed description, it should be understood that there are numerous variations. It should also be understood that one or more exemplary embodiments are only examples and are not intended to limit the scope, applicability, or configuration of the present disclosure in any way. Rather, the foregoing detailed description will provide those skilled in the art with a convenient detailed roadmap for implementing one or more exemplary embodiments.

### REFERENCE NUMERALS

1 System
2 Electronic device
3 Programmer
3a Smartphone
3b Desktop computer
3c Tablet computer
3d Custom controller
4 Luminaire
5 Dimming interface
6 First communication module
7 Second communication module
8 NFC interface
9 Bluetooth interface
10 Power supply module
11 Power source
20 Method
21 User
22 Processing step
23 Processing step
24 Processing step
25 Processing step
26 Processing step
27 Processing step
28 Processing step
29 Processing step
30 Processing step
31 Processing step
32 Processing step
33 Processing step
34 Processing step
35 Processing step
36 Processing step
37 Processing step

What is claimed is:

1. A method for configuring a configurable electronic device comprising a first communication module and a second communication module through a programmer, wherein the method comprises:
establishing a wireless connection between the programmer and the first communication module;
sending a first set of parameters from the programmer to the first communication module for parameterizing the second communication module;
sending a second set of parameters from the second communication module to the programmer via the first communication module; and
establishing a wireless direct connection between the programmer and the second communication module when the programmer receives the second set of parameters.

2. The method according to claim 1, wherein the second set of parameters is at least partially encrypted in the first communication module before being sent to the programmer.

3. The method according to claim 1, further comprising:
sending a set of device parameters from the programmer to the second communication module via the direct connection for parameterizing the configurable electronic device.

4. The method according to claim 1, further comprising:
retrieving a set of backup data for configuring the configurable electronic device.

5. The method according to claim 1, further comprising:
visualizing current device parameters on a user interface of the programmer.

6. The method according to claim 5, further comprising:
modifying visualized device parameters via the user interface of the programmer.

7. The method according to claim 6, further comprising:
sending modified parameters to the second communication module and updating a configuration of the configurable electronic device based on the modified parameters.

8. The method according to claim 1, wherein at least one of:
communication between the first communication module and the programmer is based on a near-field wireless communication protocol; and
communication between the second communication module and the programmer is based on a short-range wireless communication protocol.

9. The method according to claim 1, wherein the configurable electronic device is a configurable driver for driving a light source.

10. A configurable electronic device comprising a first communication module and a second communication module, wherein the first communication module and the second communication module are operatively connected to each other and configured for wireless communication with a programmer, wherein the first communication module is configured to:
receive a first set of configuration parameters for parameterizing the second communication module from the programmer; and
forward the first set of configuration parameters to the second communication module, wherein the second communication module is configured to receive the first set of configuration parameters and send a second set of configuration parameters to the programmer via the first communication module for establishing a direct wireless connection between the programmer and the second communication module when the programmer receives the second set of configuration parameters.

11. The configurable electronic device according to claim 10, wherein the first communication module is configured to encrypt the second set of configuration parameters before sending the second set of configuration parameters to the programmer.

12. The configurable electronic device according to claim 10, wherein:
the first communication module comprises a memory unit configured to store backup data; and
the second communication module is configured to retrieve the backup data from the memory unit of the first communication module.

13. The configurable electronic device according to claim 10, wherein the second communication module is configured to execute an update of configuration of the electronic device when receiving modified parameters from the programmer.

14. The configurable electronic device according to claim 10, wherein:
the first communication module is configured to communicate with the programmer based on a near-field wireless communication protocol; and
the second communication module is configured to communicate with the programmer based on a short-range wireless communication protocol.

15. A system comprising:
the configurable electronic device according to claim 10; and
the programmer for configuring the configurable electronic device, wherein the programmer:
is configured for wireless communication with the first communication module and the second communication module of the electronic device; and
comprises a user interface configured to receive user input for configuring the configurable electronic device.
